(19) United States
(12) Patent Application Publication
(10) Pub. No.: US 2022/0383411 A1
(43) Pub. Date: Dec. 1, 2022

(54) METHOD AND SYSTEM FOR ASSESSING SOCIAL MEDIA EFFECTS ON MARKET TRENDS

(71) Applicant: JPMorgan Chase Bank, N.A., New York, NY (US)

(72) Inventors: Salwa Husam ALAMIR, Bournemouth (GB); Sameena SHAH, Scarsdale, NY (US); Armineh NOURBAKHSH, Brooklyn, NY (US)

(73) Assignee: JPMorgan Chase Bank, N.A., New York, NY (US)

(21) Appl. No.: 17/335,869

(22) Filed: Jun. 1, 2021

(51) Int. Cl. G06Q 40/04; G06Q 50/00

(52) U.S. Cl. CPC G06Q 40/04; G06Q 50/01

(57) ABSTRACT

A method and system for monitoring social media to identify signals for trading equities in the stock market are provided. The method includes: monitoring social media platforms for posts that relate to stocks that are tradeable on a market; determining a list of stocks that correspond to a large volume of the social media posts, and determining whether the sentiment of the posts is positive, negative, or neutral; obtaining recent price history data for the listed stocks; analyzing the price history data with respect to the volumes and sentiments of the social media posts; and predicting expected trends in the stock prices of the listed stocks.

### BACKGROUND

### 1. Field of the Disclosure

This technology generally relates to methods and systems for assessing social media effects on market trends, and more particularly to methods and systems for monitoring social media to identify sentiments as signals for trading equities in the stock market.

### BACKGROUND INFORMATION

In recent months, the global pandemic has caused an influx in the number of individuals who participate in trading on the stock market, i.e., day-traders. Often, day-traders communicate with one another via forums that are available in social media. The increase in the number of day-traders has been sufficient to have a noticeable effect on the stock market. For example, this effect was evident during the recent short squeeze of Gamestop stock.

Accordingly, there is a need fix a mechanism to monitor social media to identify sentiments that may act as signals for trading equities in the stock market.

### SUMMARY

The present disclosure, through one or more of its various aspects, embodiments, and/or specific features or sub-components, provides, inter alia, various systems, servers, devices, methods, media, programs, and platforms for monitoring social media to identify sentiments as signals for trading equities in the stock market.

According to an aspect of the present disclosure, a method for monitoring social media to identify signals for trading equities in the stock market is provided. The method is implemented by at least one processor. The method includes: monitoring, by the at least one processor over a first predetermined time interval, at least one social media platform for posts that relate to stocks that are tradeable on a market; determining, by the at least one processor based on a result of the monitoring, a first subset of the stocks that corresponds to a greatest volume of the posts and a corresponding volume of each respective stock included in the first subset; obtaining, for each respective stock included in the first subset, data that relates to a price history of the respective stock over a second predetermined time interval; analyzing, for each respective stock included in the first subset, the obtained price history data with respect to the determined corresponding volume of the respective stock; and predicting, for each respective stock included in the first subset based on a result of the analyzing, an expected trend in a price of each respective stock included in the first subset over a third predetermined time interval.

The method may further include: determining, for each respective post that relates to a respective stock included in the first subset, a corresponding sentiment; and analyzing, for each respective stock included in the first subset, the obtained price history data with respect to the determined corresponding sentiment of each respective post that relates to the respective stock. The predicting of the expected trend in a price of each respective stock included in the first subset over the third predetermined time interval may be based on both the result of the analyzing of the obtained price history data with respect to the determined corresponding volume of the respective stock and a result of the analyzing of the obtained price history data with respect to the determined corresponding sentiment of each respective post that relates to the respective stock.

The determining of the corresponding sentiment may include determining that the respective post is at least one from among positive with respect to the respective stock, negative with respect to the respective stock, and neutral with respect to the respective stock.

The at least one social media platform may include at least one from among Reddit and Twitter

The first subset of the stocks may include ten (10) stocks. Each of the ten stocks may correspond to a greater volume of the posts than any of the stocks that is not included in the first subset.

The first predetermined interval may correspond to a most recent 24-hour period.

The second predetermined interval may correspond to a most recent one-month period.

The third predetermined interval may correspond to a next one-week period.

The method may further include parsing each respective post to determine at least one respective keyword that corresponds to the respective post.

According to another exemplary embodiment, a computing apparatus for monitoring social media to identify signals for trading equities in the stock market is provided. The computing apparatus includes a processor; a memory; and a communication interface coupled to each of the processor and the memory. The processor is configured to: monitor, over a first predetermined time interval, at least one social media platform for posts that relate to stocks that are tradeable on a market; determine, based on a result of the monitoring, a first subset of the stocks that corresponds to a greatest volume of the posts and a corresponding volume of each respective stock included in the first subset; obtain, for each respective stock included in the first subset, data that relates to a price history of the respective stock over a second predetermined time interval; analyze, for each respective stock included in the first subset, the obtained price history data with respect to the determined corresponding volume of the respective stock; and predict, for each respective stock included in the first subset based on a result of the analysis, an expected trend in a price of each respective stock included in the first subset over a third predetermined time interval.

The processor may be further configured to: determine, for each respective post that relates to a respective stock included in the first subset, a corresponding sentiment; and analyze, for each respective stock included in the first subset, the obtained price history data with respect to the determined corresponding sentiment of each respective post that relates to the respective stock. The prediction of the expected trend in a price of each respective stock included in the first subset over the third predetermined time interval may be based on both the result of the analysis of the obtained price history data. with respect to the determined corresponding volume of the respective stock and a result of the analysis of the obtained price history data with respect to the determined corresponding sentiment of each respective post that relates to the respective stock.

The processor may be further configured to determine the corresponding sentiment by determining that the respective post is at least one from among positive with respect to the respective stock, negative with respect to the respective stock, and neutral with respect to the respective stock.

The at least one social media platform may include at least one from among Reddit and Twitter.

The first subset of the stocks may include ten (10) stocks. Each of the ten stocks may correspond to a greater volume of the posts than any of the stocks that is not included in the first subset.

The first predetermined interval may correspond to a most recent 24-hour period.

The second predetermined interval may correspond to a most recent one-month period.

The third predetermined interval may correspond to a next one-week period.

The processor may be further configured to parse each respective post to determine at least one respective keyword that corresponds to the respective post.

According to yet another exemplary embodiment, a non-transitory computer readable storage medium storing instructions for monitoring social media to identify signals for trading equities in the stock market is provided. The storage medium includes executable code which, when executed by a processor, causes the processor to: monitor, over a first predetermined time interval, at least one social media platform for posts that relate to stocks that are tradeable on a market; determine, based on a result of the monitoring, a first subset of the stocks that corresponds to a greatest volume of the posts and a corresponding volume of each respective stock included in the first subset; obtain, fir each respective stock included in the first subset, data that relates to a price history of the respective stock over a second predetermined time interval; analyze, for each respective stock included in the first subset, the obtained price history data with respect to the determined corresponding volume of the respective stock; and predict, for each respective stock included in the first subset based on a result of the analyzing, an expected trend in a price of each respective stock included in the first subset over a third predetermined time interval.

The executable code may be further configured to cause the processor to: determine, for each respective post that relates to a respective stock included in the first subset, a corresponding sentiment; and analyze, for each respective stock included in the first subset, the obtained price history data with respect to the determined corresponding sentiment of each respective post that relates to the respective stock. The prediction of the expected trend in a price of each respective stock included in the first subset over the third predetermined time interval may be based on both the result of the analysis of the obtained price history data with respect o the determined corresponding volume of the respective stock and a result of the analysis of the obtained price history data with respect to the determined corresponding sentiment of each respective post that relates to the respective stock.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for monitoring social media to identify sentiments as signals for trading equities in the stock market.

FIG. 4 is a flowchart of an exemplary process for implementing a method for monitoring social media to identify sentiments as signals for trading equities in the stock market.

FIG. 5 is a flow diagram that illustrates a method for monitoring social media to identify sentiments as signals for trading equities in the stock market, in accordance with an exemplary embodiment.

FIG. 6 and FIG. 7 are screenshots of an application programming interface (API) for facilitating user interaction with an application that implements a method for monitoring social media to identify sentiments as signals for trading equities in the stock market, in accordance with an exemplary embodiment.

FIG. 8 is a graph that illustrates social media sentiment for a particular stock versus spot price of the stock over a selected time interval.

### DETAILED DESCRIPTION

Through one or more of its various aspects, embodiments and/or specific features or sub-components of the present disclosure, are intended to bring out one or more of the advantages as specifically described above and noted below

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

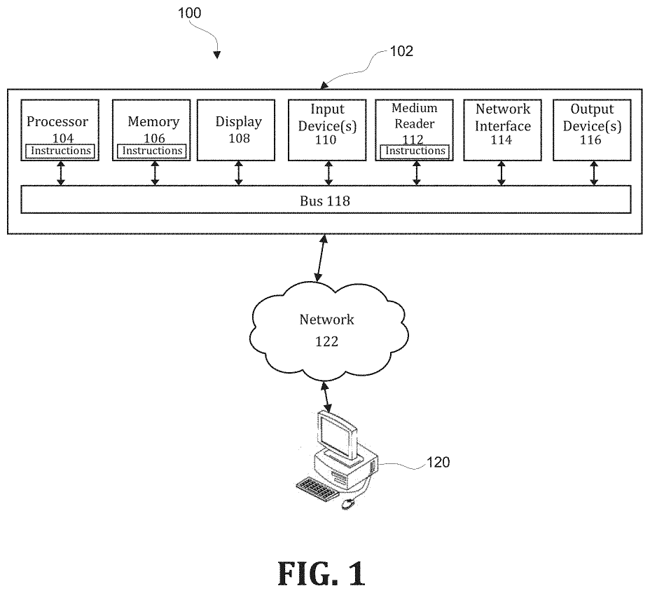

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also he a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk. or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a. liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

1Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for monitoring social media to identify sentiments as signals for trading equities in the stock market.

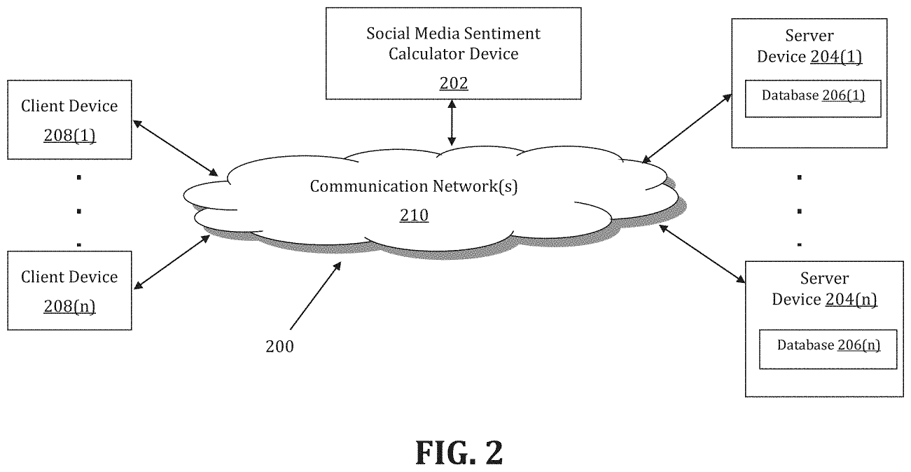

Referring to FIG. 2, a schematic of an exemplary network environment 200 for implementing a method for monitoring social media to identify sentiments as signals for trading equities in the stock market is illustrated. In an exemplary embodiment, the method is executable on any networked computer platform, such as, for example, a personal computer (PC).

The method for monitoring social media to identify sentiments as signals for trading equities in the stock market may be implemented by a Social Media Sentiment Calculator (SMSC) device 202. The SMSC device 202 may be the same or similar to the computer system 102 as described with respect to FIG. 1. The SMSC device 202 may store one or more applications that can include executable instructions that, when executed by the SMSC device 202, cause the SMSC device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based. computing environment. The application(s) may be executed within or as virtual machine(s) or virtual server(s) that may be managed in a cloud-based computing environment. Also, the application(s), and even the SMSC device 202 itself, may be located in virtual server(s) running in a cloud-based computing environment rather than being tied to one or more specific physical network computing devices. Also, the application(s) may be running in one or more virtual machines (VMs) executing on the SMSC device 202. Additionally, in one or more embodiments of this technology, virtual machine(s) running on the SMSC device 202 may be managed or supervised by a hypervisor.

In the network environment 200 of FIG, 2, the SMSC device 202 is coupled to a plurality of server devices 204(1)-204(n) that hosts a plurality of databases 206(1)-206(n), and also to a plurality of client devices 208(1)-208(n) via communication network(s) 210. A communication interface of the SMSC device 202, such as the network interface 114 of the computer system 102 of FIG. 1, operatively couples and communicates between the SMSC device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122. as described with respect to FIG. 1, although the SMSC device 202, the server devices 204(1)-204(n), and/or the client devices 208(1)-208(n) may be coupled. together via other topologies. Additionally, the network environment 200 may include other network devices such as one or more routers and/or switches, for example, which are well known in the art and thus will not be described herein. This technology provides a number of advantages including methods, non-transitory computer readable media, and SMSC devices that efficiently implement a method for monitoring social media to identify sentiments as signals for trading equities in the stock market.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched. Telephone Network (PSTNs), Ethernet-based Packet Data Networks (PDNs), combinations thereof, and the like.

The SMSC device 202 may be a standalone device or integrated with one or more other devices or apparatuses, such as one or more of the server devices 204(1)-204(n), for example. In one particular example, the SMSC device 202 may include or be hosted by one of the server devices 204(1)-204(n), and other arrangements are also possible. Moreover, one or more of the devices of the SMSC device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the SMSC device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to social media sites and posts and data that relates to stock market trends.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FICG. 1, including any features or combination of features described with respect thereto. For example, the client devices 208(1)-208(n) in this example may include any type of computing device that can interact with the SMSC device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the SMSC device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the SMSC device 202, the server devices 204(1)-204(n), the client devices 208(1)-208(n), and the communication network(s) 210 are described and illustrated herein, other types and/or numbers of systems, devices, components, and/or elements in other topologies may be used. If is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the SMSC device 202, the server devices 204(1)-204(n), or the client devices 208(1)-208(n), for example, may be configured to operate as virtual instances on the same physical machine. In other words, one or more of the SMSC device 202, the server devices 204(1)-204(n), or the client devices 208(i)-208(n) may operate on the same physical device rather than as separate devices communicating through communication network(s) 210. Additionally, there may be more or fewer SMSC devices 202, server devices 204(1)-204(n), or client devices 208(1)-208(n) than illustrated in FIG. 2.

In addition, two or more computing systems or devices may be substituted fix any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modern), wireless traffic networks, cellular traffic networks, Packet Data Networks (PDNs), the Internet, intranets, and combinations thereof.

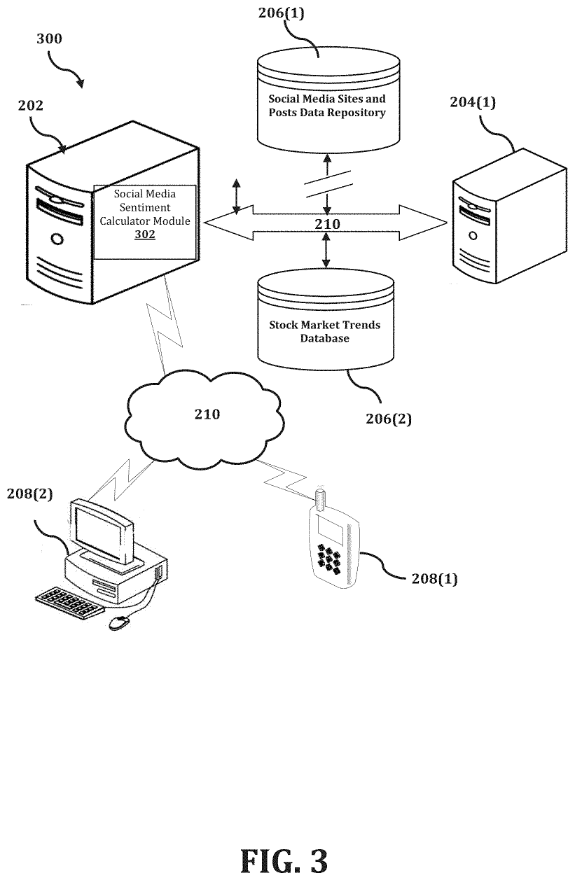

The SMSC device 202 is described and illustrated in FIG. 3 as including a social media sentiment calculator module 302, although it may include other rules, policies, modules, databases, or applications, for example. As will be described below, the social media sentiment calculator module 302 is configured to implement a method for monitoring social media to identify sentiments as signals for trading equities in the stock market.

An exemplary process 300 for implementing a mechanism for monitoring social media to identify sentiments as signals for trading equities in the stock market by utilizing the network environment of FIG. 2 is illustrated as being executed in FIG. 3. Specifically, a first client device 208(1) and a second client device 208(2) are illustrated as being in communication with SMSC device 202. In this regard, the first client device 208(1) and the second client device 208(2) may be “clients” of the SMSC device 202 and are described herein as such. Nevertheless, it is to be known and understood that the first client device 208(1) and/or the second client device 208(2) need not necessarily be “clients” of the SMSC device 202, or any entity described in association therewith herein. Any additional or alternative relationship may exist between either or both of the first client device 208(1) and the second client device 208(2) and the SMSC device 202, or no relationship may exist.

Further, SMSC device 202 is illustrated as being able to access a social media sites and posts data repository 206(1) and a stock market trends database 206(2). The social media sentiment calculator module 302 may be configured to access these databases for implementing a method for monitoring social media to identify sentiments as signals for trading equities in the stock market.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the SMSC device 202 via broadband or cellular communication. Of course, these embodiments are merely exemplary and are not limiting or exhaustive.

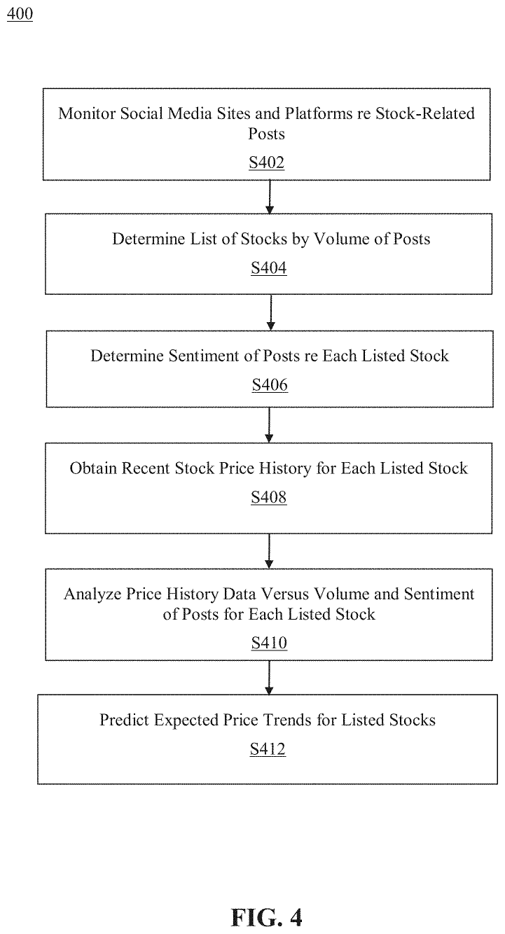

Upon being started, the social media sentiment calculator module 302 executes a process for monitoring social media to identify sentiments as signals for trading equities in the stock market. An exemplary process for monitoring social media to identify sentiments as signals for trading equities in the stock market is generally indicated at flowchart 400 in FIG. 4.

In process 400 of FIG. 4, at step S402, the social media sentiment calculator module 302 monitors social media sites and platforms for posts that relate to stocks that are tradeable on a stock market. In an exemplary embodiment, the social media sites and platforms may include any one or more of Twitter, Reddit, Facebook, histogram, Snapchat, and/or any other social media platform. The monitoring occurs over a first predetermined time interval, such as, for example, a most recent day (i.e., a most recent 24-hour period); a most recent two-day period; a most recent seven-day period; or any other suitable period of time.

At step S404, the social media sentiment calculator module 302 determines a list of stocks that corresponds to a greatest volume of the social media posts observed during the monitoring step, and also determines a corresponding volume of posts for each listed stock. In an exemplary embodiment, the list of stocks may include ten (10) stocks, where each of the ten listed stocks corresponds to a greater volume of the posts than any stock not included in the list. Alternatively, the list may include any number of stocks associated with a large volume of social media posts, such as three (3), five (5), fifteen (15), twenty (20), fifty (50), one hundred (100), or any other suitable number.

At step S406, the social media sentiment calculator module 302 determines a sentiment associated with each social media posts for each stock included in the list. In an exemplary embodiment, each social media post is determined as being positive with respect to the stock, negative with respect to the stock, or neutral with respect to the stock. For example, stock XYZ may be the subject of 500 posts on Twitter over a period of 24 hours, and among the 500 posts, 225 may be determined as being positive with respect to stock XYZ; 100 may be determined as being negative with respect to stock XYZ; and 175 may be determined as being neutral with respect to stock XYZ. In this example, the social media sentiment calculator 302 may determine that for stock XYZ, 45% of the posts are positive, 20% are negative, and 35% are neutral. Further, the social media sentiment calculator module 302 may parse each respective social media post in order to determine at least one keyword that is associated with the particular post.

At step S408, the social media sentiment calculator module 302 obtains a recent stock price history for each listed stock over a second predetermined time interval. The stock price history may be determined over a most recent one-month period, a most recent week, a most recent two-day period, a most recent one-day period, a most recent quarter (i.e., three-month period), a most recent six-month period, a most recent year, or any other suitable period of time. In an exemplary embodiment, the stock price history data may be obtained by retrieving the data from a database stored in a memory, such as, for example, stock market trends database 206(2).

At step S410, the social media sentiment calculator module 302 analyzes the stock price history data versus the determined volume of posts and the determined sentiments for each stock included in the list of stocks. In an exemplary embodiment, this analysis may be performed by using a machine learning algorithm that implements an artificial intelligence technique for comparing the stock price history data with the data associated with the volume and sentiment of the corresponding social media posts. The machine learning algorithm may be trained on historical data associated with stock prices and historical data relating to social media posts.

Then, at step S412, the social media sentiment calculator module 302 predicts an expected trend in the stock price for each stock included in the list over a third predetermined time interval. In an exemplary embodiment, when stock XYZ is associated with a large volume of social media posts that are mostly positive, the social media sentiment calculator module 302 may predict that the stock price of stock XYZ is expected to increase over the next day or the next week. Alternatively, when stock ABC is associated with negative rumors being spread via social media, the social media sentiment calculator module 302 may predict that the stock price of stock ABC is expected to decrease in advance of a scheduled announcement relating to stock ABC.

In an exemplary embodiment, when a particular stock is determined as being associated with a significant volume of social media posts that have a keyword indicating a particular action, such as a “short squeeze,” the social media sentiment calculator module 302 may predict that the stock price will increase rapidly in the short term and then fall rapidly after short sellers are forced to buy the stock at the increased price.

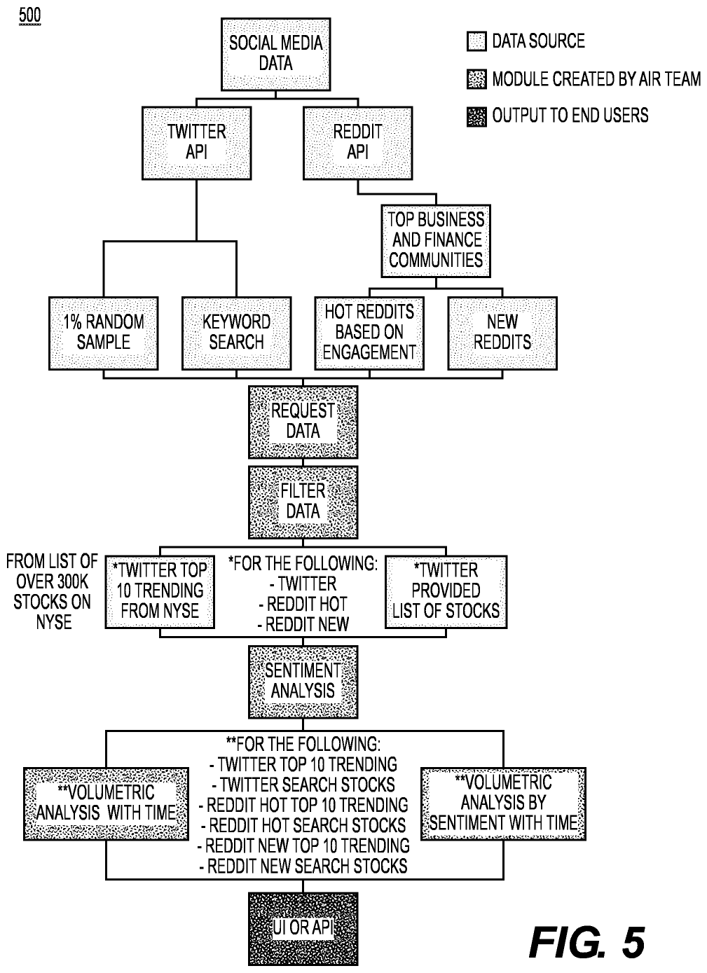

FIG. 5 is a flow diagram 500 that illustrates a method for monitoring social media to identify sentiments as signals for trading equities in the stock market, in accordance with an exemplary embodiment. As illustrated in the flow diagram 500, the method is initiated by monitoring social media data, and in an exemplary embodiment, the social media platforms to be monitored may include a Twitter application programming interface (API) and a Reddit API.

First, a data gathering operation is performed. For Twitter, a 1% random sample of all tweets may be performed, and a keyword search may also be performed. For Reddit, the method may focus on top business and financial communities. A set of hot Reddits may be determined based on engagement by participants, and new Reddits may also be identified.

After the data gathering operation is performed, the data is then requested and filtered in order to determine which stocks are associated with high volumes. In an exemplary embodiment, from among a list of over 300,000 stocks that are included in the New York Stock Exchange (NYSE), a subset that includes any one of more of the following may be selected: a Twitter top 10 trending stocks list; a Twitter search stocks list; a Reddit hot top 10 trending list; a Reddit hot search stocks list; a Reddit new top ten trending list; and a Reddit new search stocks list.

For the selected stocks, the method may implement a volumetric analysis and a sentiment analysis with respect to all of the social media posts associated with these stocks. The volumetric analysis may be performed over a predetermined time interval in association with a stock price history. The analysis may also be based on both volume and sentiment of the social media posts over the predetermined time interval with respect to the stock price history. The sentiment analysis may classify each social media post as being positive, negative, or neutral. The results of the analyses may be outputted to a user interface (UI) or an application programming interface (API) in order to enable an analyst to make decisions regarding potential trading transactions relating to the selected stocks.

In an exemplary embodiment, a method for monitoring social media to identify sentiments as signals for trading equities in the stock market is implemented by using a data request module, a filter module, and a sentiment analysis module. The data request module may be configured to request data from a Twitter API and a Reddit API.

The endpoints are described as follows:

Twitter Search API: This endpoint does a keyword search. The search is based on the tickers that are provided and returns the tweets for each stock. As part of the search, a dollar sign (“$”) is added in order to guarantee that the returned posts are stock related. This endpoint has a limit of up to 100 tweets per request. In an exemplary embodiment, the requests are submitted on a periodic basis, such as, for example, every half hour for each stock for only today's date. The tweets that were already obtained in a previous API call are dropped such that only the new non-overlapping tweets are stored.

Twitter Stream API: This endpoint randomly samples 1% of the tweets posted in real-time. In an exemplary embodiment, 10,000 tweets are obtained from this data source every half hour in order to do an analysis to detect stocks that are trending.

Reddit Hot API: This endpoint returns 100 hot Reddit posts from the top Finance and Business communities. This endpoint is requested in order to detect trending stocks in Reddit.

Reddit New API: This endpoint returns 100 new Reddit posts from the top Finance and Business communities. This endpoint is also requested in order to detect trending stocks in Reddit.

Reddit Search API: This endpoint does a keyword search, which is based on the tickers that are provided, and which returns the Reddit posts for each stock. As part of the search, a dollar sign (“$”) is added in order to guarantee that the returned posts are stock related. This endpoint has a limit of up to 100 tweets per request. in an exemplary embodiment, the requests are submitted on a periodic basis, such as, for example, every half hour for each stock for only today's date. The Reddit posts that were already obtained in a previous API call are dropped such that only the new non-overlapping posts are stored.

filter Module: In an exemplary embodiment, tasks may be filtered by removing any duplicates by new requests and only counting posts where the ticker name is prefixed with a dollar sign (“$”). Further, bots may be filtered by counting the number of posts within a certain time period by a particular user and then, when the number of posts exceeds a predetermined threshold, fixture posts from this particular user may be disregarded.

Sentiment Analysis: In an exemplary embodiment, a lexicon-based and sentiment analyzer that is specifically attuned on social media data is used. This is run on each tweet from Twitter and the title of each post from Reddit. The output is a score between −1 and 1 at the post level, and the ticker mentioned by the post. The posts are then classified into: 1) positive (i.e., for scores that are greater than 0.05); 2) negative (i.e., for scores that are less than −0.05); or 3) neutral (i.e., for scores that are greater than or equal to −0.05 and less than or equal to 0.05).

Further, the sentiment analysis module may also include an aspect-based sentiment analyzer that can detect a sentiment that is targeted to a specific ticker, as opposed to than the sentiment of the post as a whole. In an exemplary embodiment, the aspect-based sentiment analyzer may be implemented by using Bidirectional Encoder Representations from Transformers (BERT)-based models. A list of keywords to be incorporated into this analyzer may include the following: 1) Positive: Buy; Bought; Upside; Add; Cheap; Straight up; Rally; Hold; Eke (without the word “don't”); Double; Triple; Moon; [Rocket Ship Emoji]; and classic positive sentiment phrases (e.g., “great”, “amazing”, etc.). 2) Negative: Sell; Tank; Crash; Sold; Out; Dump; Zero; and classic negative sentiment phrases (e.g., “awful”, “horrible”, “hate”, etc.

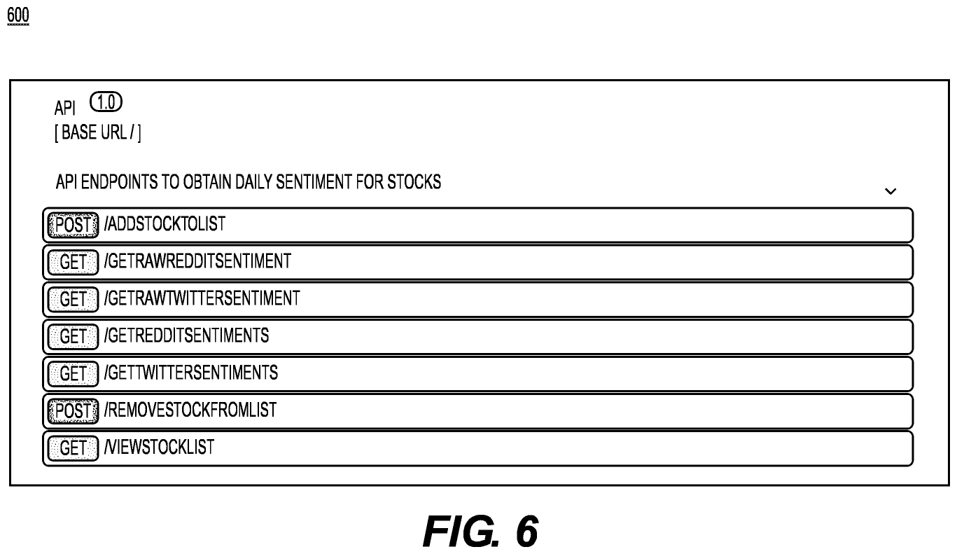

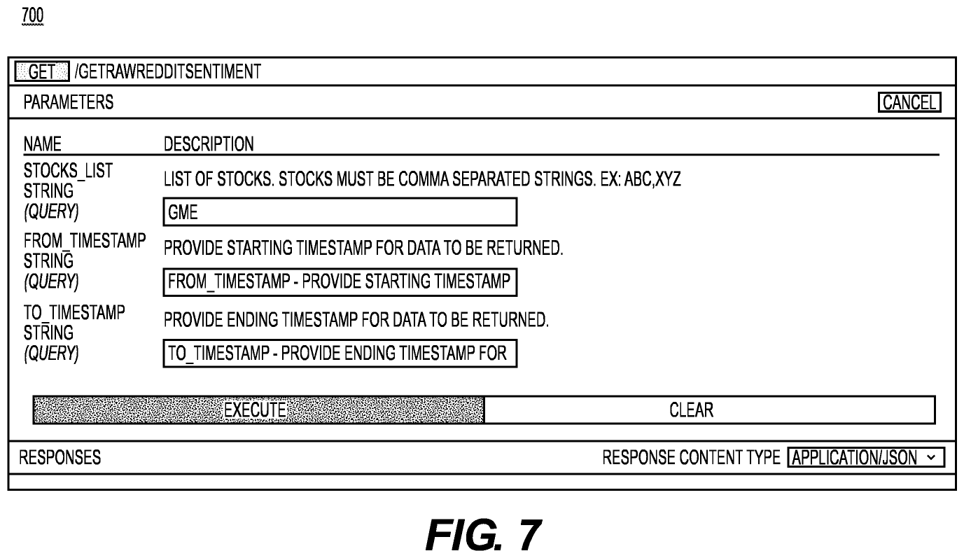

FIG. 6 and FIG. 7 are respective screenshots 600 and 700 of an application programming interface (API) for facilitating user interaction with an application that implements a method for monitoring social media to identify sentiments as signals for trading equities in the stock market, in accordance with an exemplary embodiment.

In the screenshot 600 of FIG. 6, an API includes seven prompts for API endpoints that are configured to obtain daily sentiment for stocks. These prompts include the following: 1)/addStockToList: Add a stock to the list of stocks for search API's; 2)/removeStockFromUst: Remove a stock from the list of stock being monitored; 3)/viewStockList: Display all the stocks being searched for and/or monitored; 4)/getRedditSentiments: Get Reddit sentiments aggregated at half hour increments; 5)/getTwitterSentiments: Get Twitter sentiments aggregated at half hour increments; 6)/getRawRedditSentiment: Get Reddit sentiment as “raw” data, i.e, sentiment for each individual Reddit post; and 7)/getRawTwitterSentiment: Get twitter sentiment as “raw” data, i.e., sentiment for each individual tweet.

In the screenshot 700 of FIG. 7, the API displays an example in which a user has clicked on/getRawRedditSentiment, and is then prompted to provide input to identify a list of stocks, a starting time, and an ending time. The user has inputted “GME” to denote a stock for CiameStop Corporation. The API also includes an Execute button, and when this button is clicked by the user, an output result may be provided in JSON format, and a request URL that can be used to make an API call may also be provided.

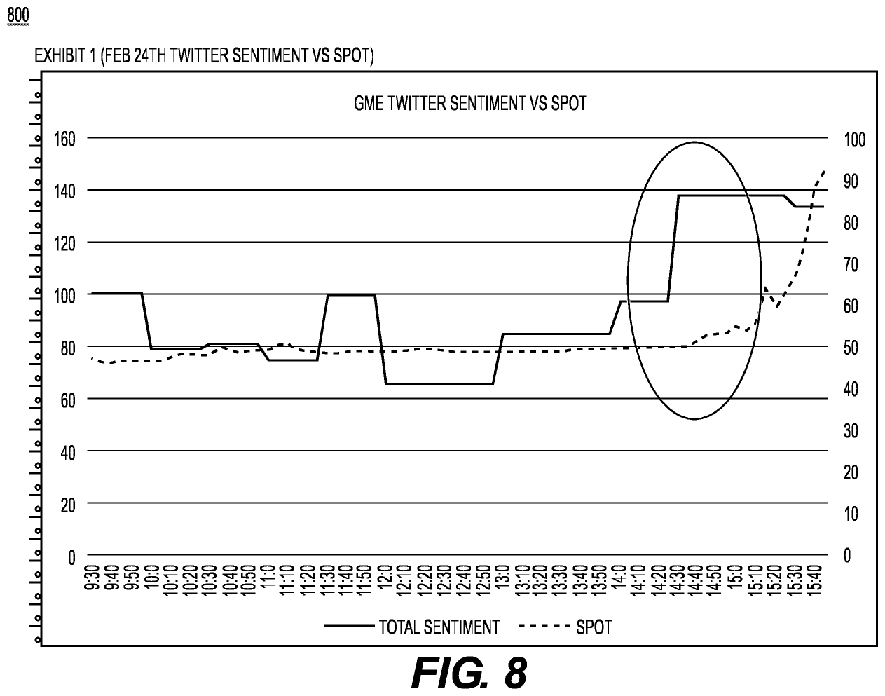

FIG. 8 is a graph 800 that illustrates social media sentiment for a particular stock versus spot price of the stock over a selected time interval. In the graph 800 of FIG. 8, Twitter sentiment for GME is plotted versus the spot price for GME stock. As emphasized in the encircled section on the right-hand side of the graph, the sentiment peaks before the spot price begins a sharp increase, thereby suggesting that the positive social media sentiment acts as a leading indicator for predicting changes in the stock price.

Accordingly, with this technology, an optimized process for monitoring social media to identify sentiments as signals for trading equities in the stock market is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

1. A method for monitoring social media to identify signals for trading equities in the stock market, the method being implemented by at least one processor, the method comprising:
monitoring, by the at least one processor over a first predetermined time interval, at least one social media platform for posts that relate to stocks that are tradeable on a market;
determining, by the at least one processor based on a result of the monitoring, a first subset of the stocks that corresponds to a greatest volume of the posts and a corresponding volume of the posts for each respective stock included in the first subset;
obtaining, for each respective stock included in the first subset, data that relates to a price history of the respective stock over a second predetermined time interval;
analyzing, for each respective stock included in the first subset, the obtained price history data with respect to the determined corresponding volume of the respective stock; and
predicting, for each respective stock included in the first subset based on a result of the analyzing, an expected trend in a price of each respective stock included in the first subset over a third predetermined time interval,
wherein the analyzing is performed by using a machine learning algorithm that implements an artificial intelligence technique for comparing the price history data to the determined corresponding volume of the respective stock, the machine learning algorithm being trained by using stock price historical data and historical data with respect to social media posts.

2. The method of claim 1, further comprising:
determining, for each respective post that relates to a respective stock included in the first subset, a corresponding sentiment; and
analyzing, for each respective stock included in the first subset and by using the machine learning algorithm, the obtained price history data with respect to the determined corresponding sentiment of each respective post that relates to the respective stock,
wherein the predicting of the expected trend in a price of each respective stock included in the first subset over the third predetermined time interval is based on both the result of the analyzing of the obtained price history data with respect to the determined corresponding volume of the respective stock and a result of the analyzing of the obtained price history data with respect to the determined corresponding sentiment of each respective post that relates to the respective stock.

3. The method of claim 2, wherein the determining of the corresponding sentiment comprises determining that the respective post is at least one from among positive with respect to the respective stock, negative with respect to the respective stock, and neutral with respect to the respective stock.

4. The method of claim 1, wherein the at least one social media platform includes at least one from among a Reddit social media platform and a Twitter social media platform.

5. The method of claim 1, wherein the first subset of the stocks includes ten (10) stocks, and wherein each of the ten stocks corresponds to a greater volume of the posts than any of the stocks that is not included in the first subset.

6. The method of claim 1, wherein the first predetermined interval corresponds to a most recent 24-hour period.

7. The method of claim 1, wherein the second predetermined interval corresponds to a most recent one-month period.

8. The method of claim 1, wherein the third predetermined interval corresponds to a next one-week period.

9. The method of claim 1, further comprising parsing each respective post to determine at least one respective keyword that corresponds to the respective post.

10. A computing apparatus for monitoring social media to identify signals for trading equities in the stock market, the computing apparatus comprising:
a processor;
a memory; and
a communication interface coupled to each of the processor and the memory,
wherein the processor is configured to:
monitor, over a first predetermined time interval, at least one social media platform for posts that relate to stocks that are tradeable on a market;
determine, based on a result of the monitoring, a first subset of the stocks that corresponds to a greatest volume of the posts and a corresponding volume of the posts for each respective stock included in the first subset;
obtain, for each respective stock included in the first subset, data that relates to a price history of the respective stock over a second predetermined time interval;
analyze, for each respective stock included in the first subset, the obtained price history data with respect to the determined corresponding volume of the respective stock; and
predict, for each respective stock included in the first subset based on a result of the analysis, an expected trend in a price of each respective stock included in the first subset over a third predetermined time interval,
wherein the analysis is performed by using a machine learning algorithm that implements an artificial intelligence technique for comparing the price history data to the determined corresponding volume of the respective stock, the machine learning algorithm being trained by using stock price historical data and historical data with respect to social media posts.

11. The computing apparatus of claim 10, wherein the processor is further configured to:
determine, for each respective post that relates to a respective stock included in the first subset, a corresponding sentiment; and
analyze, for each respective stock included in the first subset and by using the machine learning algorithm, the obtained price history data with respect to the determined corresponding sentiment of each respective post that relates to the respective stock,
wherein the prediction of the expected trend in a price of each respective stock included in the first subset over the third predetermined time interval is based on both the result of the analysis of the obtained price history data with respect to the determined corresponding volume of the respective stock and a result of the analysis of the obtained price history data with respect to the determined corresponding sentiment of each respective post that relates to the respective stock.

12. The computing apparatus of claim 11, wherein the processor is further configured to determine the corresponding sentiment by determining that the respective post is at least one from among positive with respect to the respective stock, negative with respect to the respective stock, and neutral with respect to the respective stock.

13. The computing apparatus of claim 10, wherein the at least one social media platform includes at least one from among a Reddit social media platform and a Twitter social media platform.

14. The computing apparatus of claim 10, wherein the first subset of the stocks includes ten (10) stocks, and wherein each of the ten stocks corresponds to a greater volume of the posts than any of the stocks that is not included in the first subset.

15. The computing apparatus of claim 10, wherein the first predetermined interval corresponds to a most recent 24-hour period.

16. The computing apparatus of claim 10, wherein the second predetermined interval corresponds to a most recent one-month period.

17. The computing apparatus of claim 10, wherein the third predetermined interval corresponds to a next one-week period.

18. The computing apparatus of claim 10, wherein the processor is further configured to parse each respective post to determine at least one respective keyword that corresponds to the respective post.

19. A non-transitory computer readable storage medium storing instructions for monitoring social media to identify signals for trading equities in the stock market, the non-transitory computer readable storage medium comprising executable code which, when executed by a processor, causes the processor to:
monitor, over a first predetermined time interval, at least one social media platform for posts that relate to stocks that are tradeable on a market;
determine, based on a result of the monitoring, a first subset of the stocks that corresponds to a greatest volume of the posts and a corresponding volume of the posts for each respective stock included in the first subset;
obtain, for each respective stock included in the first subset, data that relates to a price history of the respective stock over a second predetermined time interval;
analyze, for each respective stock included in the first subset, the obtained price history data with respect to the determined corresponding volume of the respective stock; and
predict, for each respective stock included in the first subset based on a result of the analyzing, an expected trend in a price of each respective stock included in the first subset over a third predetermined time interval,
wherein the analysis is performed by using a machine learning algorithm that implements an artificial intelligence technique for comparing the price history data to the determined corresponding volume of the respective stock, the machine learning algorithm being trained by using stock price historical data and historical data with respect to social media posts.

20. The non-transitory computer readable storage medium of claim 19, wherein the executable code is further configured to cause the processor to:
determine, for each respective post that relates to a respective stock included in the first subset, a corresponding sentiment; and
analyze, for each respective stock included in the first subset and by using the machine learning algorithm, the obtained price history data with respect to the determined corresponding sentiment of each respective post that relates to the respective stock,
wherein the prediction of the expected trend in a price of each respective stock included in the first subset over the third predetermined time interval is based on both the result of the analysis of the obtained price history data with respect to the determined corresponding volume of the respective stock and a result of the analysis of the obtained price history data with respect to the determined corresponding sentiment of each respective post that relates to the respective stock.
